(19) United States
(12) Patent Application Publication
(10) Pub. No.: US 2005/0201359 A1
(43) Pub. Date: Sep. 15, 2005

(54) Dynamically establishing media channels between resources of an emergency services network and conforming emergency systems

(75) Inventors: Michael Jay Nelson, Louisville, CO (US); Gregory Wilfred Bruening, Boulder, CO (US); Stephen Lynn Bulick, Boulder, CO (US); Edward Kizhner, Colorado Springs, CO (US); Stephen Marc Meer, Niwot, CO (US); Dennis Michael Neumayer, Golden, CO (US); Robert Allen Sherry, Aurora, IL (US)

Correspondence Address: SETTER OLLILA, LLC, 2060 BROADWAY, SUITE 300, BOULDER, CO, 80302, US

(73) Assignee: Intrado Inc., Longmont, CO (US)

(21) Appl. No.: 10/817,738

(22) Filed: Apr. 2, 2004

Related U.S. Application Data
(60) Provisional application No. 60/552,839, filed on Mar. 13, 2004.

(51) Int. Cl. H04L 12/66

(52) U.S. Cl. 370/352; 370/401; 370/404

(57) ABSTRACT

The invention includes a communication network for dynamically establishing media channels between conforming emergency systems (CES) and resources of an emergency services network. The CES transmits a request message for a media channel to the packet network. One of the resources of the emergency services network receives the request message. The resource responds to the request message to dynamically establish the media channel. The CES may then exchange messages with the resource over the media channel to facilitate the CES in handling emergency events. In other embodiments, a resource transmits a request message for a media channel to the packet network. The CES receives the request message, and responds to the request message to dynamically establish the media channel. The CES and the resource may then exchange messages over the media channel to facilitate the CES in handling emergency events.

### RELATED APPLICATIONS

This non-provisional application claims priority to U.S. provisional application 60/552,839, which was filed on Mar. 13, 2004.

### BACKGROUND OF THE INVENTION

1. Field of the Invention

The invention is related to the field of emergency services, and in particular, to networks, methods, and systems for dynamically establishing media channels between resources of an emergency services network and conforming emergency systems.

2. Statement of the Problem

In the United States, basic 9-1-1 service is an emergency reporting service where a calling party can dial 9-1-1 in emergency situations. The call is answered at a Public Safety Answering Point (PSAP, also known as a “Public Safety Access Point”). An operator at the PSAP converses with the calling party to determine information on the emergency situation. For instance, the operator may ask the calling party for his/her name, the nature of the emergency, and the location of the emergency, etc. Based on the information gathered by the operator, the operator then contacts emergency personnel to respond to the emergency.

Enhanced 9-1-1 service (E9-1-1) has the added feature of automatically providing the operator with some information on the calling party. For instance, E9-1-1 service includes the added features of Automatic Number Identification (ANI) and Automatic Location Identification (ALI). With Automatic Number Identification (ANI), the operator is automatically provided with telephone number of the phone placing the call for emergency services (e.g., a 9-1-1 call). With Automatic Location Identification (ALI), the PSAP, or another device, queries an ALI database for information on the physical location of the calling party's phone. An ALI database stores records of telephone numbers. A record in the ALI database contains information (such as a street address) on a physical location that corresponds with a telephone number. Responsive to a query from the PSAP, the ALI database returns the location information for the calling party. With the telephone number and the location information, the operator can more effectively handle the emergency call. Other countries have emergency services similar to this.

Traditional communication networks have a rigid architecture when it comes to connecting to an emergency services network. In a traditional communication network, a PSAP connects to a pair of ALI databases in the emergency services network. A pair of ALI databases is used for redundancy and reliability. The PSAP connects to each ALI database over a dedicated point-to-point connection, which may be problematic. The ALI databases interface the PSAP with the emergency services network. The PSAP is not able to dynamically connect with other ALI databases or other resources in the emergency services network. The PSAP is unfortunately dependant on the pair of ALI databases to provide information for an emergency call.

Also, if one of the ALI databases were to be taken out of service for maintenance or upgrades, then the PSAP would be connected to a single ALI database and would become one-sided. If the remaining ALI database was to go out of service, then the PSAP would not be able to adequately service emergency calls. Emergency services administrators try to avoid architectures that rely on a single device or system because of the higher possibility of a service outage.

### SUMMARY OF THE SOLUTION

The invention helps solve the above and other problems by dynamically establishing media channels between resources of an emergency services network and conforming emergency systems (e.g., PSAPs or other conforming systems). By dynamically establishing media channels, a conforming emergency system may communicate with more than just a pair of ALI databases. The conforming emergency system may communicate with different resources over media channels. Thus, the conforming emergency system may receive information for an emergency event more quickly and effectively. Also, the conforming emergency system would not be left one-sided if an ALI database were to be taken out of service.

One embodiment of the invention comprises a communication network for dynamically establishing media channels between resources of an emergency services network and conforming emergency systems. A conforming emergency system transmits a request message for a media channel to a packet network. One of the resources of the emergency services network receives the request message. The resource responds to the request message to dynamically establish the media channel between the conforming emergency system and the resource over the packet network. The conforming emergency system may then exchange messages with the resource over the media channel to facilitate the conforming emergency system in handling emergency events.

In responding to the request message, the resource may transmit a response message to the packet network that indicates an acceptance of the media channel. Responsive to receiving the response message, the conforming emergency system may initiate a process to dynamically establish the media channel between the conforming emergency system and the resource.

Alternatively, in responding to the request message, the resource may initiate a process to dynamically establish the media channel between the conforming emergency system and the resource.

In another embodiment of the invention, one of the resources transmits a request message for a media channel to the packet network. A conforming emergency system receives the request message. The conforming emergency system responds to the request message to dynamically establish the media channel between the conforming emergency system and the resource over the packet network. The resource and conforming emergency system may then exchange messages over the media channel to facilitate the conforming emergency system in handling emergency events.

In responding to the request message, the conforming emergency system may transmit a response message to the packet network that indicates an acceptance of the media channel. Responsive to receiving the response message, the resource may initiate a process to dynamically establish the media channel between the resource and the conforming emergency system.

Alternatively, in responding to the request message, the conforming emergency system may initiate a process to dynamically establish the media channel between the conforming emergency system and the resource.

The invention may include other networks, systems, and methods described below.

### DESCRIPTION OF THE DRAWINGS

The same reference number represents the same element on all drawings.

FIG. 1 illustrates a communication network that provides emergency services in the prior art, such as 9-1-1 service in the United States.

FIG. 2A illustrates a communication network in an exemplary embodiment of the invention.

FIG. 2B is a flow chart illustrating a method for dynamically establishing media channels between resources and conforming emergency systems in the communication network of FIG. 2A in an exemplary embodiment of the invention.

FIG. 2C is a flow chart illustrating another method for dynamically establishing media channels between resources and conforming emergency systems in the communication network of FIG. 2A in an exemplary embodiment of the invention.

FIG. 3A illustrates the communication network of FIG. 2A further including a channel setup system in an exemplary embodiment of the invention.

FIG. 3B is a flow chart illustrating a method for using the channel setup system to assist in dynamically establishing media channels in the communication network of FIG. 3A in an exemplary embodiment of the invention.

FIG. 3C is a flow chart illustrating another method for using the channel setup system to assist in dynamically establishing media channels in the communication network of FIG. 3A in an exemplary embodiment of the invention.

FIG. 4 illustrates a channel setup system in an exemplary embodiment of the invention.

FIG. 5 illustrates another communication network in an exemplary embodiment of the invention.

FIG. 6 illustrates the configuration of a PSAP and a response gateway in the communication network of FIG. 5 in an exemplary embodiment of the invention.

### DETAILED DESCRIPTION OF THE INVENTION

Description of the Prior Art

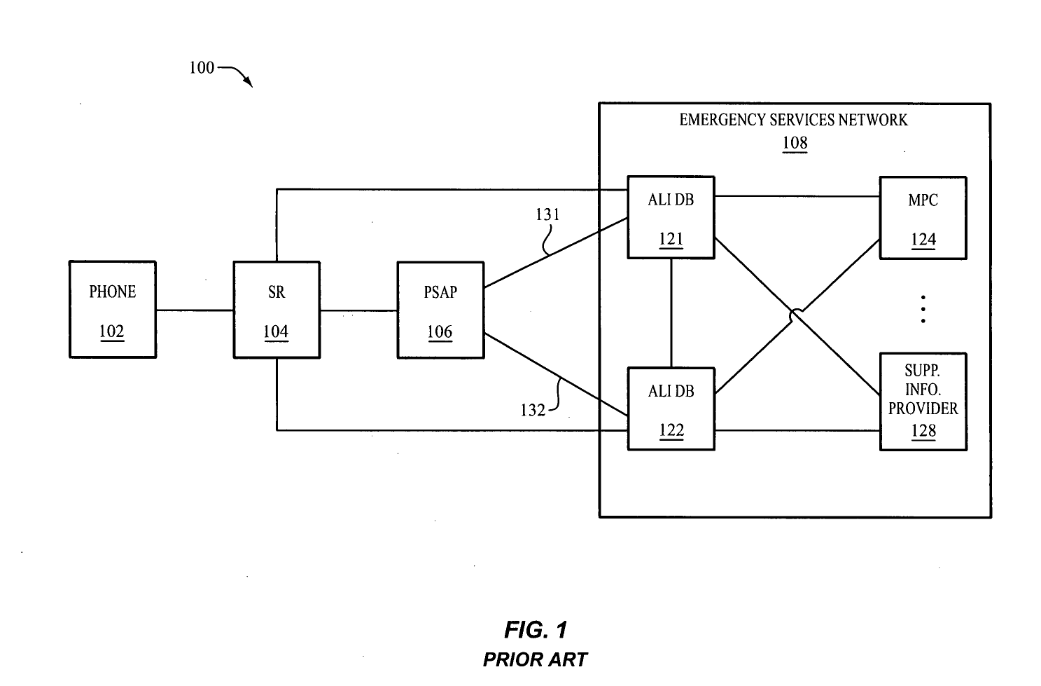

FIG. 1 illustrates a prior art communication network 100 that provides emergency services. Communication network 100 includes a telephone 102, a selective router (SR) 104, a Public Safety Answering Point (PSAP) 106, and an emergency services network 108. Emergency services network 108 includes two ALI databases 121-122, a Mobile Positioning Center (MPC) 124 (or a Gateway Mobile Location Center (GMLC)), a supplemental information provider 128, and other backend resources (not shown). Although a single MPC 124 and a single supplemental information provider 128 are illustrated in FIG. 1, emergency services network 108 generally includes multiple MPCs and supplemental information providers. As shown in FIG. 1, telephone 102 is connected to selective router 104. Selective router 104 is connected to PSAP 106 and ALI databases 121-122. PSAP 106 is connected to ALI databases 121-122. ALI database 121 is connected to ALI database 122, MPC 124, and supplemental information provider 128. ALI database 122 is connected to ALI database 121, MPC 124, and supplemental information provider 128.

Paired ALI databases 121-122 are used in emergency services networks, such as emergency service network 108, to add redundancy and reliability into the network. Each PSAP 106 (only one is shown) connects to two ALI databases 121-122. For the PSAP-ALI interface, PSAP 106 is connected to ALI database 121 by a dedicated point-to-point connection 131, and is connected to ALI database 122 by a dedicated point-to-point connection 132. The PSAP-ALI interface traditionally includes fixed point-to-point data circuits utilizing asynchronous data modems for the dedicated connections 131-132. In newer versions of the PSAP-ALI interface, dedicated connections 131-132 may include an upgraded transport protocol, such as Internet Protocol (IP) or X.25. Regardless of the transport protocol, the logical connections between PSAP 106 and ALI databases 121-122 remain point-to-point dedicated connections 131-132.

To illustrate how communication network 100 operates, assume that a caller dials 9-1-1 or a similar emergency number on telephone 102. Selective router 104 receives the emergency call, such as through a central office (not shown), a tandem switch (not shown), etc. Selective router 104 also receives an Emergency Service Number (ESN) associated with the location of the calling party from one or more ALI databases 121-122 or from another database (not shown). In FIG. 1, based on the ESN, selective router 104 selects PSAP 106 to handle the call and routes the emergency call to PSAP 106. Networks may route the emergency call to PSAP 106 in different ways depending on the desired implementation. Some examples of different implementations are illustrated in U.S. Pat. No. 6,415,018, U.S. Pat. No. 6,584,307, U.S. Pat. No. 6,385,302, and U.S. Pat. No. 6,587,545, which are all incorporated herein by reference to the same extent as if fully set forth herein.

Emergency services network 108, which provides E9-1-1 services, includes Automatic Location Identification (ALI) services. When PSAP 106 receives the emergency call, PSAP 106 also receives an ANI for the call. The ANI, which is the telephone number of the calling party telephone 102, allows an operator in PSAP 106 to call the calling party back if the call happens to be terminated. The ANI also allows the PSAP 106 to fetch information on the physical location of the calling party in order to dispatch the appropriate emergency personnel (e.g., police, ambulance, fire department). To fetch the location information, PSAP 106 generates a request for the location information that includes the ANI of telephone 102, and forwards the request to ALI database 121 over dedicated connection 131. PSAP 106 may forward the request to ALI database 122 over dedicated connection 132 in addition to forwarding the request to ALI database 121 or instead of forwarding the request to ALI database 121.

ALI database 121 receives the request for location information that includes the ANI. ALI database 121 searches for location information corresponding with the ANI. If ALI database 121 finds location information corresponding with the ANI, then ALI database 121 responds to PSAP 106 with the location information. If ALI database 121 does not find location information corresponding with the ANI, then ALI database 121 may have to query other ALI databases or other databases or systems for the location information.

ALI database 121 acts as an intermediary between PSAP 106 and the other emergency services in emergency services network 108. PSAP 106 does not directly connect with emergency services other than ALI databases 121-122. PSAP 106 communicates with MPC 124 and supplemental information provider 128 through one or both of ALI databases 121-122. For instance, if telephone 102 is a mobile phone, then ALI database 121 queries MPC 124 or another MPC (not shown) for location information corresponding with the ANI and forwards the location information to PSAP 106. ALI database 121 may provide supplemental information provider 128 with the ANI, and supplemental information provide 128 may provide services such as notifying third parties of the emergency call. In each of these cases, ALI database 121 interfaces PSAP 106 with the other emergency services.

When PSAP 106 receives a response from ALI database 121, PSAP 106 should be better informed to handle the emergency call. For instance, PSAP 106 should have location information for the calling party. PSAP 106 then informs the appropriate emergency personnel of the emergency call so that the emergency personnel can be quickly dispatched.

One problem with current emergency services networks is that the PSAP-ALI interface uses dedicated point-to-point connections 131-132 between PSAP 106 and ALI databases 121-122. PSAP 106 is not able to dynamically connect with another ALI database (not shown) or another resource in emergency services network 108. PSAP 106 is dependant on the pair of ALI databases 121-122 to provide information for an emergency call. If one of the ALI databases 121 were to be taken out of service for maintenance or upgrades, then PSAP 106 would be connected to a single ALI database 122 and become one-sided. If the remaining ALI database 122 was to go out of service, then PSAP 106 would not be able to adequately service emergency calls. Emergency services administrators try to avoid architectures that rely on a single device or system because of the higher possibility of a service outage.

Another problem with current emergency services networks is the traditional PSAP-ALI interface uses a limited message set. Most conventional PSAPs fundamentally include the same design as when they were initially conceived in the 1970's. The conventional PSAPs are configured to receive a fixed-length, pre-defined text string. The fixed-length text string limits the number of fields and the size of the fields that can be included in the text string. The small size of the text stream severely constrains the amount of information that the ALI database can provide to the PSAP, the context that can be created, and the data types that can be supported. Emergency services administrators have had to “overload” the text string, using the same fixed-length field for multiple purposes in different contexts, to provide the current services. New services or new capabilities are very difficult to add if the text string is overloaded by the current services. For instance, an ALI database would not be able to provide or would only be able to provide very limited individual medical information to the PSAP. Also, the technology does not lend itself to streaming video to the PSAP as the traditional message set does not have the capacity.

Another problem with current emergency services networks is that the PSAP-ALI interface model is a request-response model. The PSAP forwards a request for ALI information to the ALI database, and the ALI database provides a response to the PSAP. Under the current model, the PSAP has to initiate communication with the ALI database with a request for ALI information. The ALI database is not allowed or equipped to initiate a communication with the PSAP, or deliver ALI information to the PSAP unless the PSAP submits a request. The current PSAP-ALI interface model limits the types of enhanced services provided by the emergency services network.

The following example illustrates some of the problems and limitations of the current emergency services networks. Assume that telephone 102 comprises a mobile telephone and that a user of telephone 102 dials 9-1-1. Selective router 104 routes the 9-1-1 call to PSAP 106. PSAP 106 submits a request to ALI database 121 for information for the 9-1-1 call. The request includes an ANI. Responsive to receiving the request, ALI database 121 determines that the ANI is a pseudo-ANI corresponding with a wireless service provider for telephone 102. The ANI is not the actual telephone number of telephone 102, but is a key corresponding with basic information identifying the wireless service provider and/or identifying the cell tower from which the 9-1-1 call originated.

Because the pseudo-ANI is for a wireless service provider, ALI database 121 does not have location information for the pseudo-ANI. Consequently, ALI database 121 cannot immediately provide the location information to PSAP 106 because it must attempt to retrieve location information for telephone 102. ALI database 121 retrieves the location information by submitting a request to the wireless service provider's MPC 124. Because the PSAP-ALI interface allows only one response to a request, ALI database 121 attempts to collect all call information before responding to PSAP 106. ALI database 121 also attempts to ensure that PSAP 106 receives a response within a reasonable amount of time. Before submitting the request to MPC 124, ALI database 121 sets a timer to indicate how long it will wait for MPC 124 to respond. If MPC 124 responds within the time period, then ALI database 121 responds to PSAP 106 with the location information on telephone 102. The location information may be approximate X, Y coordinates (longitude and latitude) of telephone 102 (assuming a wireless Phase II system).

If MPC 124 does not respond within the time period, then ALI database 121 responds to PSAP 106 with basic call information. The basic call information does not specify the location of telephone 102. The basic call information may merely be information on the wireless service provider or information on the cell tower from which the 9-1-1 call originated. If MPC 124 responds to ALI database 121 with the location information after ALI database 121 has already responded to PSAP 106 with the basic information, ALI database 121 cannot provide the location information on telephone 102 to PSAP 106. As previously stated, ALI database 121 cannot transmit information to PSAP 106 unless PSAP 106 has previously transmitted a request to ALI database 121 that remains unanswered. To obtain the location information from ALI database 121, PSAP 106 will have to submit another request to ALI database 121 for the same information (sometimes referred to as a re-bid).

If ALI database 121 receives another request from PSAP 106, then ALI database 121 will need to determine whether to send the previous location information received from MPC 124, request new location information from MPC 124, handle time-out scenarios, and handle situations where this request may be for a new 9-1-1 call using the same pseudo-ANI. This scenario is further complicated because the ALI database 121 does not know when this call ends and another call with the same pseudo-ANI begins. Thus, ALI database 121 uses an elaborate scheme of timers to determine if the information received from MPC 124 is stale, and determines whether it should return the information for subsequent requests from PSAP 106 or whether it should submit new requests to MPC 124. While ALI database 121 is requesting information from MPC 124 and PSAP 106 is waiting for a response, PSAP 106 may be connected with a calling party possibly engaged in a life or death situation where any bit of information might help determine the best course of action. ALI database 121 cannot tell that it takes more time to determine location information for telephone 102 because of technology overhead. PSAP 106 may have to wait 10 to 15 seconds to be told nothing more than that the 9-1-1 call is a wireless call.

The PSAP-ALI interface puts the PSAP operator in a guessing game. The PSAP operator does not know when the wireless call location information becomes available and does not know how often re-bids should be submitted to receive initial or new information. PSAP operators are taught not to push the re-bid button repeatedly in hopes of getting caller information, as this could have the opposite effect and swamp ALI database 121 or MPC 124 in a manner such that PSAP 106 cannot receive a response.

As is illustrated above, the current emergency services networks use old technology, are not very flexible in updating or improving existing services, and are not readily expandable to add new and better services. The importance of emergency services networks demands that these networks evolve to provide the best and most reliable services.

### DESCRIPTION OF THE INVENTION

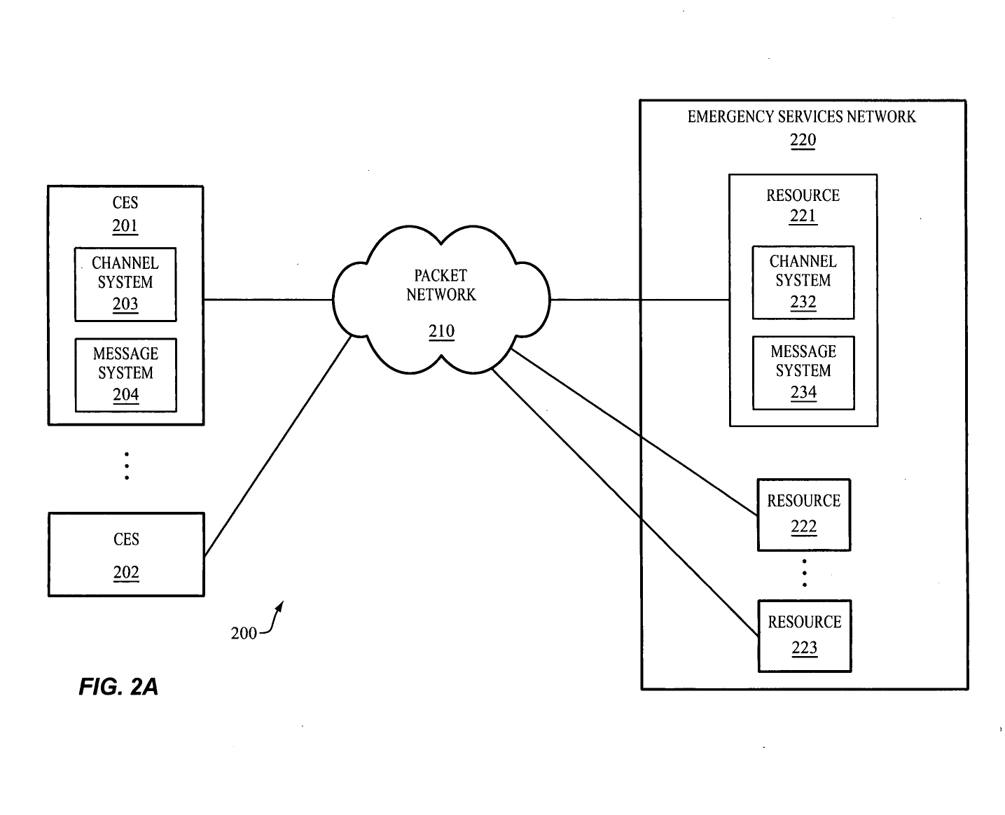

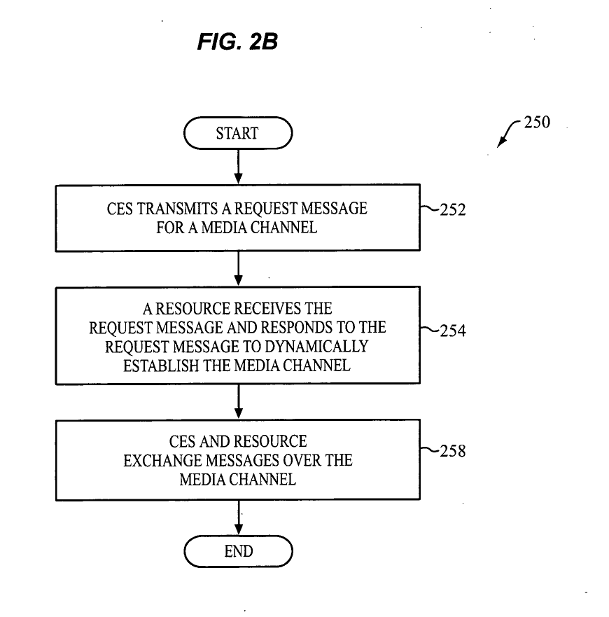

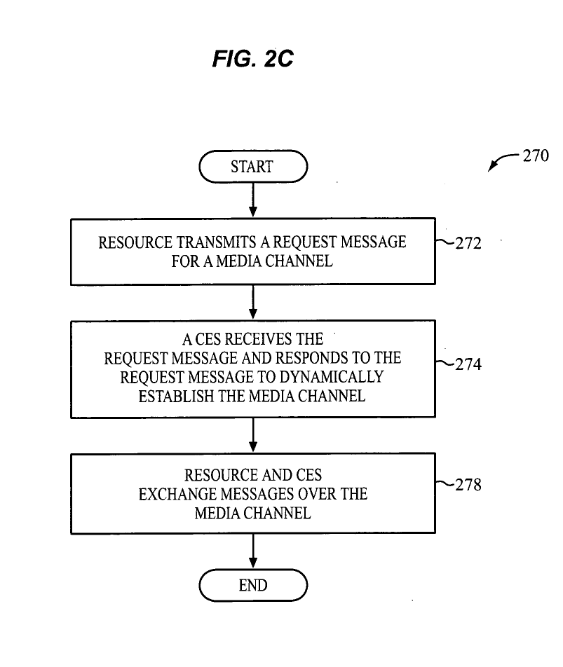

FIGS. 2A-2C, 3A-3C, and 4-6 and the following description depict specific embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 2A illustrates a communication network 200 in an exemplary embodiment of the invention. Communication network 200 includes conforming emergency systems (CES) 201-202, a packet network 210, and an emergency services network 220. Emergency services network 220 includes a plurality of resources 221-223. Conforming emergency systems 201-202 and resources 221-223 are connected to packet network 210. Communication network 200 may include other devices, resources, or systems not shown in FIG. 2A for the sake of brevity. Emergency services network 220 may include many more resources in addition to the ones shown in FIG. 2A. FIG. 2A is intended to illustrate communication network 200 in a more functional manner than a physical manner.

A conforming emergency system comprises any system, device, or equipment configured to communicate according to the message set used by an emergency services network to access emergency services (not shown) to handle emergency events. One example of a conforming emergency system is a computer system for a Public Safety Answering Point (PSAP) conforming to the message set used by an emergency services network. A PSAP is known in the art of emergency services as a location where an emergency call (e.g., a 9-1-1 call) is answered. Another example of a conforming emergency system is a computer system for a hospital, a police department, a fire station, a fire alarm company, a security company, an ambulance service, a state 9-1-1 coordinator, the Federal Emergency Management Agency (FEMA), the Department of Homeland Security, the National Geophysical Data Center, the Center for Disease Control (CDC), etc, that conforms to the message set used by an emergency services network and is used to access in emergency services to handle emergency events. An emergency event comprises any instance or situation where a request for emergency services may be made. Examples of an emergency event include any abbreviated number call (e.g., a 9-1-1 call in the U.S., a 3-1-1 call in the U.S., and a 1-1-2 call in Europe), any call or request from a computer, a PDA, a TDD device, or any other device for emergency services, an email message, an SMS message, an Internet message, a call or signal to an emergency call center (e.g., an independent alarm service, OnStar®, etc), or any other request for emergency services.

A packet network comprises any network that uses a protocol or means for supporting data and information in the form of packets or cells. Examples of a packet network include an Internet Protocol (IP) network, a frame relay network, an X.25 network, an Asynchronous Transfer Mode (ATM) network, etc. A resource comprises any system, device, equipment, or server configured to communicate with a conforming emergency system via a media channel over a transport network to facilitate the handling of emergency events. An example of a resource includes a response gateway. A media channel comprises any communication path or paths (logical, virtual, or otherwise) over a transport network configured to transport data such as streaming video, streaming audio, voice, graphics, text data, binary data, executable instructions or scripts, etc. A media channel is not a physical point-to-point dedicated connection over a transport network. The media channel may transport control messages or may operate in conjunction with a separate control channel. A response gateway comprises any system or server configured to communicate with a conforming emergency system via a media channel over a packet network, and interface the conforming emergency system with emergency services of an emergency services network.

An emergency services network includes any network or networks that provide emergency services or facilitates a conforming emergency system in handling emergency events. Emergency services comprise any services subscribed to or provided for an emergency call or other event requiring or needing such services. One example of an emergency service is an ALI database that provides location information. Another example of an emergency service is a Mobile Positioning Center (MPC) or a Gateway Mobile Location Center (GMLC) that provides location information for mobile devices. Another example of an emergency service is a Voice over Internet Protocol (VoIP) server or a selective transfer point determination system that provides location information for a VoIP phone or device. Another example of an emergency service is an Emergency Auxiliary Service Provider (EASP) or an Emergency Information Service, which are general terms for any service provider that provides information or performs a function. For instance, an EASP may contain medical information for a subscriber and information on a subscriber's premises, such as a code to a front gate, guard dogs, hazardous materials, etc. The EASP may also include a third-party notification service that notifies third parties of an emergency event. The term “emergency service” is intended to include any accompanying structure that performs the emergency services, such as processing systems, computing platforms, network interfaces, servers, etc. The function of a resource may be included in or as part of an emergency service. Thus, a resource may also include an ALI database, an MPC, a GMLC, an EASP, a VoIP server, or any other emergency service.

FIG. 2B is a flow chart illustrating a method 250 for dynamically establishing a media channel between one of the resources 221-223 and one of the conforming emergency systems (CES) 201-202 in an exemplary embodiment of the invention. In step 252, one of the conforming emergency systems (assume CES 201) transmits a request message for a media channel to packet network 210. In other embodiments, another system (such as a third-party system) may request that the media channel be established. For those embodiments, the assumption for step 252 is that CES 201 receives the request from the other system, and transmits the request message. The other system may transmit a request message to establish a media channel without the knowledge of CES 201, which is included in the scope of the invention.

One of the resources 221-223 (assume resource 221) in emergency services network 220 receives the request message, in step 254. CES 201, resource 221, or another system may include selection logic (not shown) or an algorithm for selecting resource 221. Also in step 254, resource 221 responds to the request message to dynamically establish the media channel between CES 201 and resource 221 over packet network 210. In stating that resource 221 responds to dynamically establish the media channel, either one or both of CES 201 and resource 221 may initiate and/or facilitate the dynamic establishment of the media channel. Another system may also assist in the dynamic establishment of the media channel. CES 201 and resource 221 may use Session Initiation Protocol (SIP), H.323, Signaling System No. 7 (SS7), LAPD, Q.921, Q.931, or another comparable protocol or method for dynamically establishing a media channel. In step 258, CES 201 and resource 221 may then exchange messages over the media channel to facilitate CES 201 in handling emergency events. The messages may comprise streaming video, streaming audio, voice, graphics, text data, binary data, executable instructions or scripts, or another type of data.

In responding to the request message, resource 221 may transmit a response message to packet network 210. The response message indicates an acceptance of the media channel, indicates the acceptance of parameters of the media channel, or otherwise indicates that resource 221 is available and capable of handling the media channel. Resource 221 may also negotiate parameters of the media channel before transmitting the response message. Responsive to receiving the response message, CES 201 may initiate a process to dynamically establish the media channel between CES 201 and resource 221. One example of a process initiated by CES 201 is setting up a Secure Sockets Layer (SSL) TCP/IP interface.

Alternatively, in responding to the request message, resource 221 may initiate a process to dynamically establish the first media channel between CES 201 and resource 221. One example of a process initiated by resource 221 is setting up a Secure Sockets Layer (SSL) TCP/IP interface.

In other embodiments, one of the resources 221-223 in FIG. 2A may initiate the setup of a media channel with one of the conforming emergency systems 201-202. FIG. 2C is a flow chart illustrating a method 270 for dynamically establishing a media channel between one of the resources (assume resource 223) and one of the conforming emergency systems (assume CES 201). In step 272, resource 223 transmits a request message for a media channel to packet network 210. In step 274, CES 201 receives the request message and responds to the request message to dynamically establish a media channel between CES 201 and resource 223 over packet network 210. In stating that CES 201 responds to dynamically establish the media channel, either one or both of CES 201 and resource 223 may initiate and/or facilitate the dynamic establishment of the media channel. Another system may also assist in the dynamic establishment of the media channel. CES 201 and resource 223 may use Session Initiation Protocol (SIP), H.323, Signaling System No. 7 (SS7), LAPD, Q.921, Q.931, or another comparable protocol or method for dynamically establishing a media channel. In step 278, resource 223 and CES 201 may then exchange messages over the media channel to facilitate CES 201 in handling emergency events. The messages may comprise streaming video, streaming audio, voice, graphics, text data, binary data, executable instructions or scripts, or another type of data.

In responding to the request message, CES 201 may transmit a response message to packet network 210. The response message indicates an acceptance of the media channel, indicates the acceptance of parameters of the media channel, or otherwise indicates that CES 201 is available and capable of handling the media channel. CES 201 may also negotiate parameters of the media channel before transmitting the response message. Responsive to receiving the response message, resource 223 may initiate a process to dynamically establish the media channel between CES 201 and resource 223. One example of a process initiated by resource 223 is setting up a Secure Sockets Layer (SSL) TCP/IP interface.

Alternatively, in responding to the request message, CES 201 may initiate a process to dynamically establish the first media channel between CES 201 and resource 223. One example of a process initiated by CES 201 is setting up a Secure Sockets Layer (SSL) TCP/IP interface.

One example where resource 223 may initiate a media channel is if resource 223 receives information that may be important to CES 201. For instance, resource 223 may receive a video feed from a news station on an emergency event. Responsive to receiving the video feed, resource 223 may initiate a media channel with CES 201 and other CESs potentially serving the area of the emergency event to provide the CESs with the video feed.

FIG. 2A also illustrates the configuration of CES 201 and resource 221 in communication network 200 in an exemplary embodiment of the invention. CES 201 includes a channel system 203 and a message system 204. Similarly, resource 221 includes a channel system 232 and a message system 234. CES 202 may have a similar configuration to CES 201. Resources 222-223 may have a similar configuration to resource 221. Channel system 203 and message system 204 are not necessarily two separate components, processors, devices, etc, but represent two functionalities that may be performed on a single system or multiple systems. For instance, channel system 203 and message system 204 may each represent a piece of software code being executed on a common processing system. The same rational applies for channel system 232 and message system 234. CES 201 and resource 221 may include other devices, components, or systems not shown in FIG. 2A for the sake of brevity.

Channels systems 203 and 232 are configured to setup up a media channel between CES 201 and resource 221. Channel system 203 of CES 201 transmits the request message for a media channel to packet network 210. Channel system 232 in resource 221 receives the request message from packet network 210, and responds to the request message to dynamically establish the media channel between CES 201 and resource 221. An example of channel systems 202 and 232 is a Session Initiation Protocol (SIP) user agent.

In other embodiments, channel system 203 of CES 201 receives a request message for a media channel from channel system 232 in resource 221. Channel system 203 responds to the request message to dynamically establish the media channel between CES 201 and resource 221.

With the media channel established, message systems 204 and 234 are configured to exchange messages over the established media channel. Thus, when the media channel is established between CES 201 and resource 221 in either of the manners described above, message system 204 and message system 234 exchange messages and/or information over the media channel.

Channel systems 203 and 232 and message systems 204 and 234 may be comprised of instructions that are stored on storage media (not shown). The instructions can be retrieved and executed by a processor (not shown). Some examples of instructions are software, program code, and firmware. Some examples of storage media are memory devices, tape, disks, integrated circuits, and servers. The instructions are operational when executed by the processor to direct the processor to operate in accord with the invention. The term “processor” refers to a single processing device or a group of inter-operational processing devices. Some examples of processors are computers, integrated circuits, and logic circuitry. Those skilled in the art are familiar with instructions, processors, and storage media.

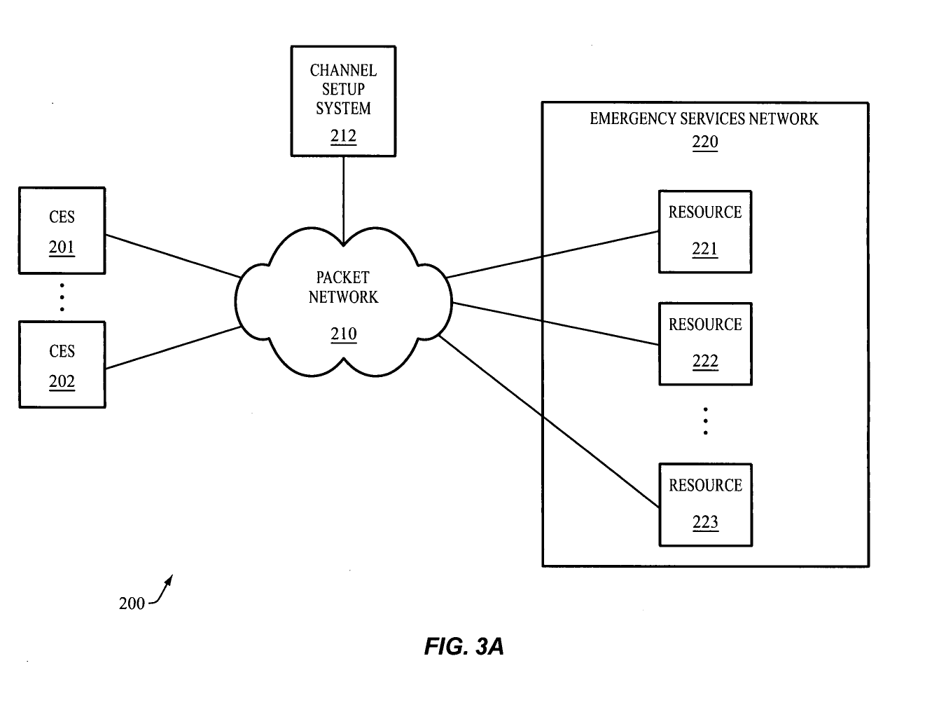

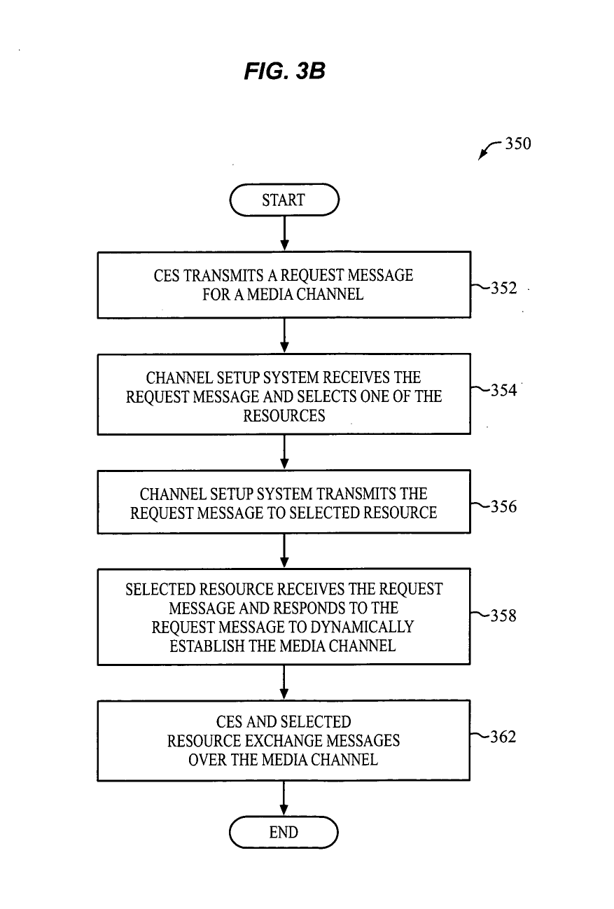

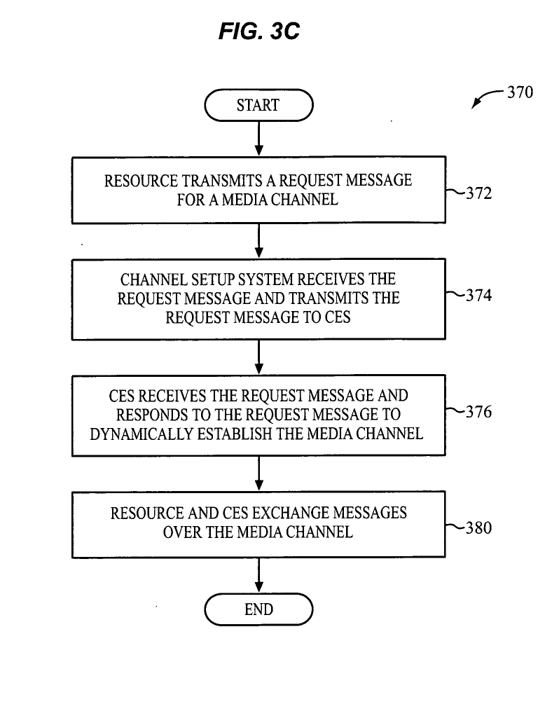

FIG. 3A illustrates communication network 200 further including a channel setup system 212 in an exemplary embodiment of the invention. Channel setup system 212 is connected to packet network 210. Channel setup system 212 comprises any system or server configured to assist in the setup of a media channel over packet network 210. Examples of channel setup system 212 include a Session Initiation Protocol (SIP) server and a SIP proxy.

FIG. 3B is a flow chart illustrating a method 350 for using channel setup system 212 to assist in dynamically establishing a media channel between one of the conforming emergency systems 201-202 (assume CES 201) and one of the resources 221-223. In step 352, CES 201 transmits a request message for a media channel to packet network 210. Channel setup system 212 receives the request message for the media channel and selects one of the resources 221-223 (assume resource 221) in emergency services network 220 with which to establish the media channel, in step 354. Channel setup system 212 may include selection logic (not shown) or an algorithm for selecting one of the resources 221-223. Channel setup system 212 then transmits the request message for the media channel to the selected resource 221 in step 356. The selected resource 221 in emergency services network 220 receives the request message. The selected resource 221 responds to the request message to dynamically establish the media channel between the selected resource 221 and CES 201, in step 358. CES 201 and the selected resource 221 then exchange messages over the media channel to facilitate CES 201 in handling emergency events, in step 362.

In responding to the request message, the selected resource 221 transmits a response message to packet network 210. The response message indicates an acceptance of the media channel, indicates the acceptance of parameters of the media channel, or otherwise indicates that the selected resource 221 is available and capable of handling the media channel. The selected resource 221 may also negotiate parameters of the media channel before transmitting the response message. In transmitting the response message to packet network 210, the selected resource 221 may transmit the response message directly to CES 201. Alternatively, the selected resource 221 may transmit the response message to channel setup system 212, and channel setup system 212 transmits the response message to CES 201. Responsive to receiving the response message, CES 201 may initiate a process to dynamically establish the media channel between CES 201 and the selected resource 221.

Alternatively, in responding to the request message, the selected resource 221 may initiate a process to dynamically establish the first media channel between CES 201 and the selected resource 221.

If resource 221 and CES 201 cannot agree on parameters for the media channel, then resource 221 transmits a response message indicating a rejection of the media channel. Resource 221 may transmit the response message directly to CES 201 or may transmit the response message to CES 201 through channel setup system 212. If CES 201 receives a response message indicating a rejection of the media channel, then CES 201 may initiate and transmit a new request message over packet network 210. If channel setup system 212 receives a response message indicating a rejection of the media channel, then channel setup system 212 may select another one of the resources 222-223 and transmit the request message to the newly selected resource.

CES 201, channel setup system 212, and resource 221 may use Session Initiation Protocol (SIP), H.323, Signaling System No. 7 (SS7), LAPD, Q.921, Q.931, or another comparable protocol or method for dynamically establishing a media channel. Channel setup system 212 may comprise a SIP proxy or a SIP server, and the request message may comprise a SIP Invite message. Channel setup system 212, CES 201, and/or resources 221-223 are able to tear down the media channel after a time period or responsive to instructions.

In other embodiments, channel setup system 212 may assist in the setup of a media channel between one of the resources 221-223 (assume resource 223) and one of the conforming emergency systems 201-202 (assume CES 201) that is initiated by a resource. FIG. 3C is a flow chart illustrating a method 370 for using channel setup system 212 to assist in dynamically establishing a media channel in an exemplary embodiment of the invention. In step 372, resource 223 transmits a request message for a media channel to packet network 210. Channel setup system 212 receives the request message for the media channel and transmits the request message for the media channel to CES 201 in step 374. CES 201 responds to the request message to dynamically establish a media channel between CES 201 and resource 223 over packet network 210, in step 376. Resource 223 and CES 201 then exchange messages over the media channel to facilitate CES 201 in handling emergency events, in step 380.

In responding to the request message, CES 201 may transmit a response message to packet network 210. The response message indicates an acceptance of the media channel, indicates the acceptance of parameters of the media channel, or otherwise indicates that CES 201 is available and capable of handling the media channel. CES 201 may also negotiate parameters of the media channel before transmitting the response message. In transmitting the response message to packet network 210, CES 201 may transmit the response message directly to resource 223. Alternatively, CES 201 may transmit the response message to channel setup system 212, and channel setup system 212 transmits the response message to resource 223. Responsive to receiving the response message, resource 223 may initiate a process to dynamically establish the media channel.

Alternatively, in responding to the request message, CES 201 may initiate a process to dynamically establish the first media channel between CES 201 and resource 223.

Channel setup system 212 may also initiate a media channel between a CES and a resource. To do so, channel setup system 212 generates a request message and selects one of the resources 221-223 in emergency services network 220. Channel setup system 212 then transmits the request message to the resource or the CES to dynamically establish another media channel between the other resource and the CES.

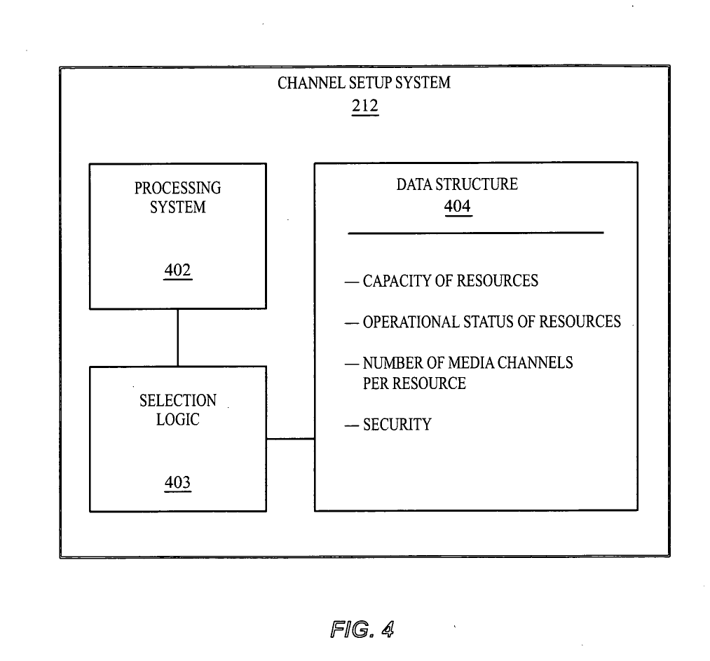

FIG. 4 illustrates channel setup system 212 in an exemplary embodiment of the invention. Channel setup system 212 includes a processor 402, selection logic 403, and a data structure 404. Data structure 404 includes information on resources 221-223 of emergency services network 220, information on routing messages to systems connected to packet network 210, and other information and data. For instance, data structure 404 may include information on the capacity or current load of each resource 221-223, information on the operational status of each resource (e.g., in service/out of service), information on the number of media channels per resource 221-223, information on security, information on the location of each resource 221-223, information on the data connectivity speed of each resource 221-223, information on the type of protocol used by each resource 221-223, information on the type of resource 221-223, etc. Data structure 404 may include much more information than that which is described. Each resource 221-223 may update channel setup system 212 as to information on that resource.

When in operation, channel setup system 212 receives a request message for a media channel. Responsive to the request message, processor 402 executes selection logic 403 to selects one of the resources 221-223 in emergency services network 220 with which to establish the media channel. Selection logic 403 may identify the availability of each of the resources 221-223 in making the selection. For instance, in making the selection, selection logic 403 accesses data structure 404 for information on the individual resources. If resource 222 is at 90% of its capacity and resource 221 is a 10% of its capacity, then selection logic 403 may select resource 221. If resource 223 has failed or has been taken out of service for maintenance, then selection logic 403 will not select resource 223. If resources 222-223 are each currently serving one media channel and resource 221 is not serving any media channels, then selection logic 403 may select resource 221 to balance out the media channels between the resources 221-223. When selection logic 403 selects one of the resources 221-223, channel setup system 212 transmits the request message for the media channel to the selected resource.

Communication network 200 is advantageously more flexible, expandable, and reliable than prior networks. CES 201 can communicate with any resource 221-223 by dynamically establishing a media channel. In traditional communication networks as shown in FIG. 1, a PSAP 106 is connected to a pair of ALI databases 121-122 by dedicated connections 131-132. This is a rigid architecture that does not allow PSAP 106 to dynamically connect with other ALI databases (not shown) or other resources in emergency services network 108. PSAP 106 is dependent on the pair of ALI databases 121 -122 to provide information. By dynamically establishing media channels within communication network 200 (see FIG. 2A), CES 201 in communication network 200 may communicate with more than just a pair of ALI databases. Consequently, CES 201 may access more information faster than it would have in prior networks. Also, CES 201 may avoid being one-sided because CES 201 can communicate with more than two ALI databases.

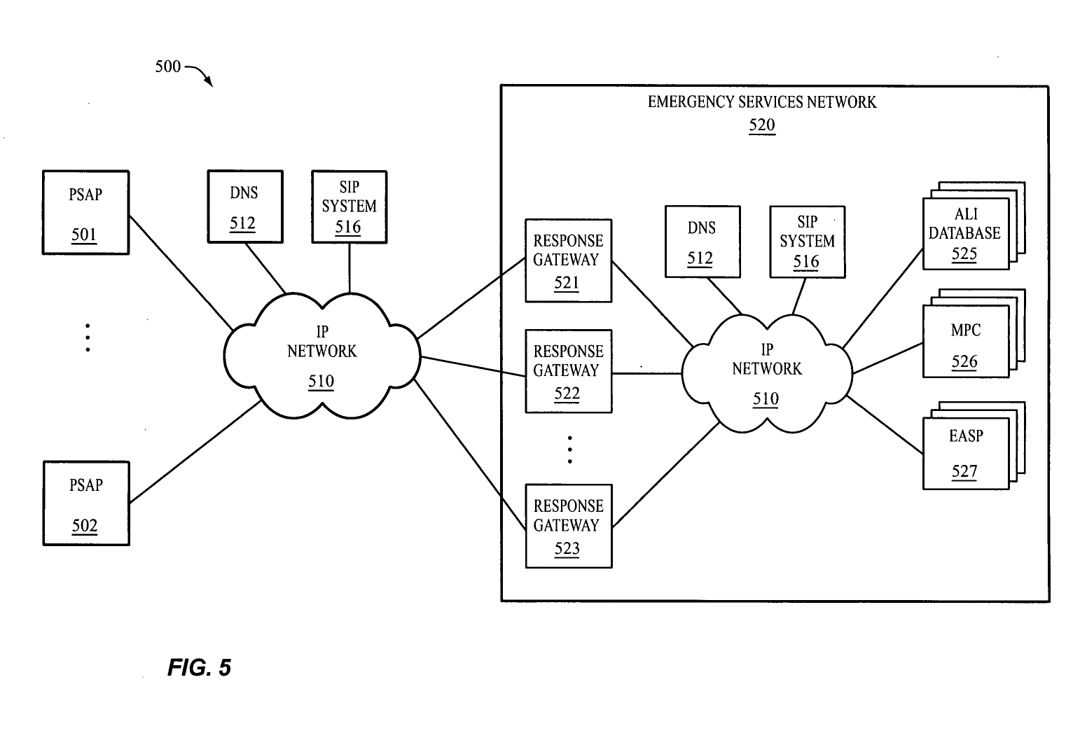

FIG. 5 illustrates another communication network 500 in an exemplary embodiment of the invention. Communication network 500 includes a plurality of PSAPs 501-502, an Internet Protocol (IP) network 510, a Domain Name Server (DNS) 512, a Session Initiation Protocol (SIP) system 516, and an emergency services network 520. Emergency services network 520 includes a plurality of response gateways 521-523, ALI databases 525, Mobile Positioning Centers (MPC) 526, and Emergency Auxiliary Service Providers (EASP) 527. PSAPs 501-502, DNS 512, SIP system 516, response gateways 521-523, ALI databases 525, MPCs 526, and EASPs 527 are connected to packet network 510. Communication network 500 may include other devices, resources, or systems not shown in FIG. 5 for the sake of brevity.

Domain name server 512 is known in the art as a system that resolves host names into IP addresses. SIP system 516 comprises any system that uses SIP to assist in dynamically establishing a media channel. Examples of SIP system 516 include a SIP proxy and a SIP server. ALI database 525 (may also be referred to as an ALI system or ALI server) is known in the art of emergency services as a system that provides information on the location of a calling party station (e.g., phone). MPC 526 is known in the art of emergency services as a system that provides information on the location of a mobile calling device (e.g., cell phone). EASP 527 comprises any emergency service configured to provide additional information for an emergency event, such as medical information, information on a subscriber's premises (e.g., guard dogs, hazardous materials, codes for a gate, etc), notify third parties of an emergency event, or provide any other services for an emergency services network.

In operation, PSAP 501 needs to access emergency services network 520 in order to obtain information on an emergency call. Unlike prior networks, PSAP 501 does not have dedicated point-to-point connections with a pair of ALI databases to obtain the information. PSAP 501 has to dynamically establish a media channel with emergency services network 520 to obtain the information.

To start, PSAP 501 initiates setup of a media channel with a response gateway 521-523 of emergency services network 520. PSAP 501 may initiate the setup of a media channel periodically based on a timer, may initiate the setup of a media channel responsive to an instruction from another device or system, or may initiate the setup of a media channel responsive to receiving an emergency call. PSAP 501 uses SIP to initiate the setup of the media channel. PSAP 501 generates an Invite message and transmits the Invite message over a TCP/IP connection to IP network 510. The TCP/IP connection may be a secure connection. The Invite message may include a host address, such as “RG@EmergProvider.com”. IP network 510 forwards the host address to DNS 512. DNS 512 resolves the host address in the Invite message to an IP address for SIP system 516, and IP network 510 forwards the Invite message to SIP system 516.

Responsive to receiving the Invite message, SIP system 516 determines which of the response gateways 521-523 is available. SIP system 516 may include logic (not shown) that is able to monitor the availability of response gateways 521-523 and determine which of the response gateways 521-523 is available. Response gateways 521-523 may periodically update SIP system 516 as to their availability and status. SIP system 516 may also query other systems (not shown) having selection logic that is able to determine which of the response gateways 521-523 is available.

SIP system 516 selects one of the response gateways 521-523 (assume response gateway 521). SIP system 516 identifies an IP address of the selected response gateway 521 and forwards the Invite message over IP network 510 to the IP address of the selected response gateway 521.

Response gateway 521 receives the Invite message from SIP system 516 along with an IP address of PSAP 501. Response gateway 521 may authenticate PSAP 501 via a login and password, via a Public Key Infrastructure (PKI) exchange of digital signatures, via public key cryptography, etc. Response gateway 521 may also access the PSAP's authorization to determine specific services available and subscribed to by PSAP 501. Response gateway 521 negotiates with PSAP 501 or SIP system 516 regarding parameters associated with the media channel to be established. Response gateway 521 may use another protocol to facilitate the negotiation of the appropriate protocol or parameters related to the media channel, such as Session Description Protocol (SDP). SDP may be carried within SIP messages to facilitate the establishment of a media channel, the version of the protocol, or parameters associated with the media channel. SDP is one way that two end-points request a media channel and agree upon the nature of the media channel. If response gateway 521 and PSAP 501 agree on the parameters for the media channel, then response gateway 521 forwards an OK message to PSAP 501. PSAP 501 receives the OK message and initiates a process to dynamically establish a media channel. An example of initiating a process is setting up a Secure Sockets Layer (SSL) TCP/IP interface.

SIP system 516 may broker any messages or negotiations between response gateway 521 and PSAP 501 instead of response gateway 521 and PSAP 501 communicating directly.

If the selected response gateway 521 is not able to accept the media channel, then SIP system 516 or another device forwards the Invite message to another response gateway 522-523. The Invite message is forwarded to response gateways 522-523 until a response gateway is found that can accept the media channel.

With the media channel established, PSAP 501 and response gateway 521 may exchange messages over the media channel to help PSAP 501 handle an emergency call. In many cases, PSAP 501 will multiplex multiple messages over the media channel. PSAP 501 and response gateway 521 may use any compatible transport protocol, such as TCP/IP, HTTP, XML, and RTP. PSAP 501 and response gateway 521 may encrypt any transmitted messages for security purposes.

The function of response gateway 521 is to interface PSAP 501 with emergency services in emergency services network 520. Thus, PSAP 501 transmits a message to response gateway 521 that includes an ANI for the emergency call. In other embodiments, a key or identifier other than an ANI may be used, such as a SIP address, a URI, etc. Based on the ANI, response gateway 521 determines which emergency services in emergency services network 520 have information corresponding with the ANI of the emergency call and the emergency services with which the ANI is associated, such as by subscription. Response gateway 521 may query individual emergency services, such as ALI database 525, EASP 527, etc., to see if they have information corresponding with the ANI. To “correspond with” in this embodiment means that an emergency service has information on an ANI or that a subscriber has subscribed to an emergency service using that ANI. Response gateway 521 may know which emergency services to contact based on the ANI or other information provided by PSAP 501. For instance, response gateway 521 may know that an emergency call originated from a wireless device, so response gateway 521 knows to query MPC 526.

Response gateway 521 may also query a global server (not shown) that indicates which emergency services, such as ALI database 525, EASP 527, etc., correspond with the ANI. The emergency services would have to register the ANIs for which they correspond with the global server.

Response gateway 521 then obtains information on the emergency call from the identified emergency services. For example, assume that ALI database 525 and EASP 527 have information on the ANI for the emergency call received by PSAP 501. Response gateway 521 establishes a media channel with ALI database 525 and obtains the information on the ANI from ALI database 525. Response gateway 521 may use SIP system 516 to establish the media channel as previously described. The media channel with ALI database 525 may also be pre-established. Response gateway 521 also establishes a media channel with EASP 527 and obtains the information on the ANI from EASP 527. The media channel with EASP 527 may also be pre-established. Response gateway 521 then transmits the information on the ANI to PSAP 501 over the media channel.

Response gateway 521 may cache the information corresponding with the ANI for a time period. If the response gateway 521 receives a request for the same ANI, then the response gateway 521 will have the information for the PSAP 501. For instance, assume that response gateway 521 transmits information on an ANI to PSAP 501 and also caches the information for a time period. Also assume that two emergency calls are made in succession from a phone corresponding with the ANI. When response gateway 521 receives the second request for the information on the ANI within the time period, response gateway 521 transmits the information on the ANI being cached in response gateway 521. Consequently, response gateway 521 may respond with information on the ANI without having to again access the emergency services.

PSAP 501 receives the information on the emergency call. PSAP 501 uses the information to handle the emergency call. For instance, PSAP 501 may use the information on the emergency call to better decide which emergency personnel to inform and/or dispatch.

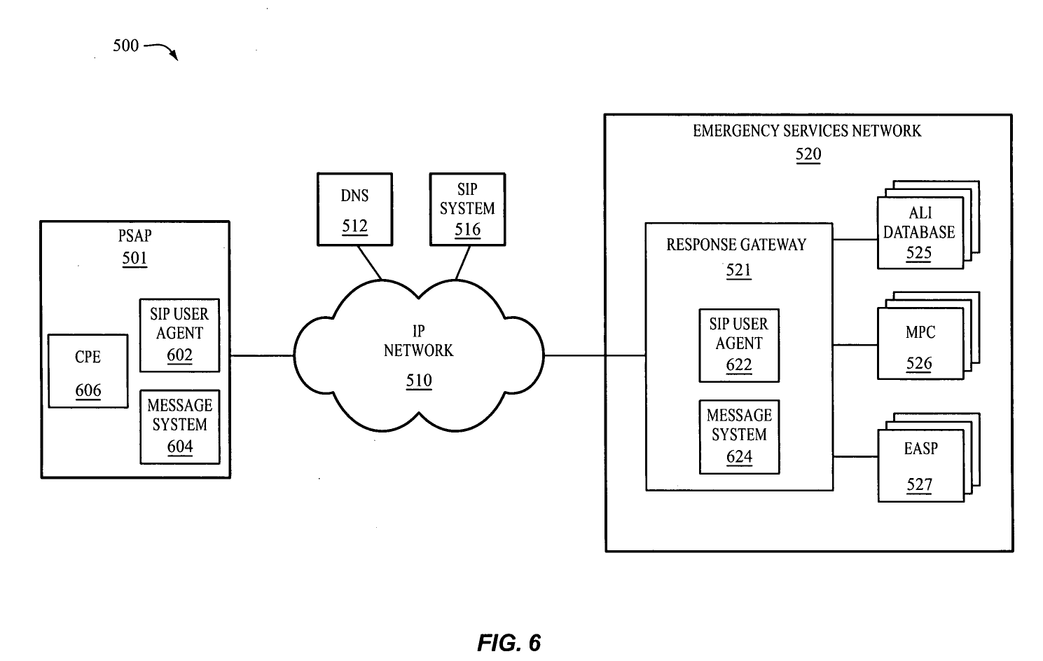

FIG. 6 illustrates the configuration of PSAP 501 and response gateway 521 in communication network 500 in an exemplary embodiment of the invention. PSAP 501 includes a SIP user agent 602, a message system 604, and Customer Premises Equipment 606. Similarly, response gateway 521 includes a SIP user agent 622 and a message system 624. PSAP 501 and resource 521 may include other devices, components, or systems not shown in FIG. 6 for the sake of brevity.

In operation, assume that PSAP 501 wants or needs to establish a media channel with emergency services network 520. To start, SIP user agent 602 of PSAP 501 forwards a SIP Invite message for a media channel to SIP system 516. SIP server 516 receives the Invite message for the media channel and selects a resource (assume resource 521) with which to establish the media channel. SIP system 516 then forwards the Invite message for the media channel to SIP user agent 622 of resource 521.

SIP user agent 622 in response gateway 521 negotiates with SIP user agent 602 in PSAP 501 or SIP system 516 regarding parameters associated with the media channel to be established. SIP user agents 602 and 622 may use another protocol to facilitate the negotiation of the appropriate protocol or parameters related to the media channel, such as Session Description Protocol (SDP). If SIP user agent 622 and SIP user agent 602 are able to agree on the parameters of the media channel, then SIP user agent 622 forwards an OK message to SIP user agent 602 in PSAP 501. PSAP 501 receives the OK message and initiates a process to dynamically establish the media channel.

With the media channel established SIP user agent 602 passes control of the media channel to message system 604. Similarly, SIP user agent 622 passes control of the media channel to message system 624. SIP user agents 602 and 622 have completed their exchange and media channel functions according to its own behavior characteristics until such time that connection parameters need to be re-negotiated or the media channel is to be terminated. Message system 604 and message system 624 may then exchange messages over the media channel to help PSAP 501 handle an emergency call. In many cases, PSAP 501 will multiplex multiple messages over the media channel having to do with the same or different emergency calls. CPE 606 represents the equipment, such as workstations, phones, screens, etc, that operators in PSAP 501 may use.

SIP user agents 602 and 622, and message systems 604 and 624 may be comprised of instructions that are stored on storage media (not shown). The instructions can be retrieved and executed by a processor (not shown), such as a processor included in CPE 606. Some examples of instructions are software, program code, and firmware. Some examples of storage media are memory devices, tape, disks, integrated circuits, and servers. The instructions are operational when executed by the processor to direct the processor to operate in accord with the invention. The term “processor” refers to a single processing device or a group of inter-operational processing devices. Some examples of processors are computers, integrated circuits, and logic circuitry. Those skilled in the art are familiar with instructions, processors, and storage media.

In conclusion, the embodiments of the invention described herein illustrate that dynamically establishing media channels between a PSAP and a resource of an emergency services network provides many advantages over the prior art.

1. A communication network for dynamically establishing media channels between conforming emergency systems and resources of an emergency services network, the communication network comprising:
a conforming emergency system (CES) connected to a packet network, the CES transmits a request message for a media channel to the packet network; and
a plurality of resources of an emergency services network each connected to the packet network, one of the resources receives the request message, and responds to the request message to dynamically establish the media channel between the CES and the one resource;
wherein the CES and the one resource exchange messages over the media channel to facilitate the CES in handling emergency events.

2. The communication network of claim 1 wherein:
the one resource responds to the request message by transmitting a response message indicating an acceptance of the media channel to the packet network; and
the CES receives the response message over the packet network and initiates a process to dynamically establish the media channel between the CES and the one resource.

3. The communication network of claim 1 wherein:
the one resource responds to the request message by initiating a process to dynamically establish the media channel between the CES and the one resource.

4. The communication network of claim 1 wherein:
the one resource negotiates parameters of the media channel.

5. The communication network of claim 1 further comprising:
a channel setup system connected to the packet network, the channel setup system receives the request message from the CES, selects the one resource in the emergency services network, and transmits the request message to the one resource.

6. The communication network of claim 5 wherein:
the channel setup system selects the one resource by identifying the availability of each of the plurality of resources in the emergency services network.

7. The communication network of claim 5 wherein:
the channel setup system includes a data structure that stores information on the plurality of resources, the channel setup system accesses the information in the data structure to select the one resource.

8. The communication network of claim 7 wherein the information in the data structure includes at least one of a capacity or current load of each of the plurality of resources, an operational status of each of the plurality of resources, a number of media channels established with each of the plurality of resources, security, a location of each resource, data connectivity speed of each resource, the type of protocol used by each resource, and the type of each resource.

9. The communication network of claim 5 wherein:
the one resource responds to the request message by transmitting a response message indicating an acceptance of the media channel to the channel setup system; and
the channel setup system receives the response message and transmits the response message to the CES.

10. The communication network of claim 5 wherein:
the one resource responds to the request message by transmitting a response message indicating an acceptance of the media channel to the CES.

11. The communication network of claim 5 wherein the channel setup system comprises a Session Initiation Protocol (SIP) proxy or a SIP server.

12. The communication network of claim 5 wherein:
the channel setup system generates another request message, selects another one of the resources in the emergency services network, and transmits the other request message to the other resource to dynamically establish another media channel between the other resource and the CES.

13. The communication network of claim 1 wherein the CES and the one resource use Session Initiation Protocol (SIP) to dynamically establish the media channel.

14. The communication network of claim 13 wherein the request message comprises a SIP Invite message.

15. The communication network of claim 1 wherein the CES or the one resource tears down the media channel.

16. The communication network of claim 1 wherein the plurality of resources includes a response gateway.

17. The communication network of claim 1 wherein the plurality of resources includes at least one of an ALI database, a Mobile Positioning Center (MPC), a Gateway Mobile Location Center (GMLC), an Emergency Auxiliary Service Provider (EASP), and a Voice over Internet Protocol (VoIP) server.

18. The communication network of claim 1 wherein the CES comprises a computer system for a Public Safety Answering Point (PSAP).

19. The communication network of claim 1 wherein the CES comprises a computer system for one of a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

20. The communication network of claim 1 wherein the emergency events include 9-1-1 calls.

21. The communication network of claim 1 wherein the CES exchanges at least one of streaming video, streaming audio, voice, graphics, text data, binary data, and executable instructions or scripts over the media channel.

22. A method of operating a communication network for dynamically establishing media channels between a conforming emergency system and a plurality of resources of an emergency services network, the method comprising the steps of:
transmitting a request message for a media channel from the conforming emergency system (CES) to a packet network;
receiving the request message in one of the resources of the emergency services network over the packet network, and responding to the request message in the one resource to dynamically establish the media channel between the CES and the one resource; and
exchanging messages over the media channel between the CES and the one resource to facilitate the CES in handling emergency events.

23. The method of claim 22 wherein the step of responding to the request message comprises transmitting a response message indicating an acceptance of the media channel from the one resource to the packet network, and further comprising the steps of:
receiving the response message in the CES over the packet network, and initiating a process in the CES to dynamically establish the media channel between the CES and the one resource.

24. The method of claim 22 wherein the step of responding to the request message comprises:
initiating a process in the one resource to dynamically establish the media channel between the CES and the one resource.

25. The method of claim 22 further comprising the step of:
negotiating parameters of the media channel before dynamically establishing the media channel.

26. The method of claim 22 wherein the communication network further comprises a channel setup system connected to the packet network, the method further comprising the steps of:
receiving the request message in the channel setup system from the CES, selecting the one resource in the emergency services network, and transmitting the request message to the one resource.

27. The method of claim 26 wherein the step of selecting the one resource in the channel setup system comprises:
selecting the one resource by identifying the availability of each of the plurality of resources in the emergency services network.

28. The method of claim 26 wherein the channel setup system includes a data structure that stores information on the plurality of resources, and the step of selecting the one resource in the channel setup system comprises:
accessing the information in the data structure to select the one resource.

29. The method of claim 28 wherein the information in the data structure includes at least one of a capacity or current load of each of the plurality of resources, an operational status of each of the plurality of resources, a number of media channels established with each of the plurality of resources, security, a location of each resource, data connectivity speed of each resource, the type of protocol used by each resource, and the type of each resource.

30. The method of claim 26 wherein the step of responding to the request message comprises transmitting a response message indicating the acceptance of the media channel from the one resource to the channel setup system, the method further comprising the step of:
receiving the response message in the channel setup system and transmitting the response message to the CES.

31. The method of claim 26 wherein the step of responding to the request message comprises transmitting a response message indicating the acceptance of the media channel from the one resource to the CES.

32. The method of claim 26 wherein the channel setup system comprises a Session Initiation Protocol (SIP) proxy or a SIP server.

33. The method of claim 26 further comprising the steps of:
generating another request message in the channel setup system, selecting another one of the resources in the emergency services network, and transmitting the other request message to the other resource to dynamically establish another media channel between the other resource and the CES.

34. The method of claim 22 further comprising the step of:
dynamically establishing the media channel using Session Initiation Protocol (SIP).

35. The method of claim 34 wherein the request message comprises a SIP Invite message.

36. The method of claim 22 further comprising the step of:
tearing down the media channel.

37. The method of claim 22 wherein the plurality of resources includes a response gateway.

38. The method of claim 22 wherein the plurality of resources includes at least one of an ALI database, a Mobile Positioning Center (MPC), a Gateway Mobile Location Center (GMLC), an Emergency Auxiliary Service Provider (EASP), and a Voice over Internet Protocol (VoIP) server.

39. The method of claim 22 wherein the CES comprises a computer system for a Public Safety Answering Point (PSAP).

40. The method of claim 22 wherein the CES comprises a computer system for one of a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

41. The method of claim 22 wherein the emergency events include 9-1-1 calls.

42. The method of claim 22 wherein the step of exchanging messages comprises:
exchanging at least one of streaming video, streaming audio, voice, graphics, text data, binary data, and executable instructions or scripts over the media channel.

43. A communication network for dynamically establishing media channels between conforming emergency systems and resources of an emergency services network, the communication network comprising:
a plurality of resources of an emergency services network each connected to a packet network, one of the resources transmits a request message for a media channel to the packet network; and
a conforming emergency system (CES) connected to the packet network, the CES receives the request message, and responds to the request message to dynamically establish the media channel between the CES and the one resource;
wherein the CES and the one resource exchange messages over the media channel to facilitate the CES in handling emergency events.

44. The communication network of claim 43 wherein:
the CES responds to the request message by transmitting a response message indicating an acceptance of the media channel to the packet network; and
the one resource receives the response message over the packet network and initiates a process to dynamically establish the media channel between the CES and the one resource.

45. The communication network of claim 43 wherein:
the CES responds to the request message by initiating a process to dynamically establish the media channel between the CES and the one resource.

46. The communication network of claim 43 wherein:
the CES negotiates parameters of the media channel.

47. The communication network of claim 43 further comprising:
a channel setup system connected to the packet network, the channel setup system receives the request message from the one resource, and transmits the request message to the CES.

48. The communication network of claim 47 wherein:
the CES responds to the request message by transmitting a response message indicating an acceptance of the media channel to the channel setup system; and
the channel setup system receives the response message and transmits the response message to the one resource.

49. The communication network of claim 47 wherein:
the CES responds to the request message by transmitting a response message indicating an acceptance of the media channel to one resource.

50. The communication network of claim 47 wherein the channel setup system comprises a Session Initiation Protocol (SIP) proxy or a SIP server.

51. The communication network of claim 47 wherein:
the channel setup system generates another request message, selects another one of the resources in the emergency services network, and transmits the other request message to the CES to dynamically establish another media channel between the other resource and the CES.

52. The communication network of claim 43 wherein the CES and the one resource use Session Initiation Protocol (SIP) to dynamically establish the media channel.

53. The communication network of claim 52 wherein the request message comprises a SIP Invite message.

54. The communication network of claim 43 wherein the CES or the one resource tears down the media channel.

55. The communication network of claim 43 wherein the plurality of resources includes a response gateway.

56. The communication network of claim 43 wherein the plurality of resources includes at least one of an ALI database, a Mobile Positioning Center (MPC), a Gateway Mobile Location Center (GMLC), an Emergency Auxiliary Service Provider (EASP), and a Voice over Internet Protocol (VoIP) server.

57. The communication network of claim 43 wherein the CES comprises a computer system for a Public Safety Answering Point (PSAP).

58. The communication network of claim 43 wherein the CES comprises a computer system for one of a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

59. The communication network of claim 43 wherein the emergency events include 9-1-1 calls.

60. The communication network of claim 43 wherein the one resource exchanges at least one of streaming video, streaming audio, voice, graphics, text data, binary data, and executable instructions or scripts over the media channel.

61. A method of operating a communication network for dynamically establishing media channels between a conforming emergency system (CES) and a plurality of resources of an emergency services network, the method comprising the steps of:
transmitting a request message for a media channel from one of the resources to a packet network;
receiving the request message in CES over the packet network, and responding to the request message to dynamically establish the media channel between the CES and the one resource; and
exchanging messages over the media channel between the CES and the one resource to facilitate the CES in handling emergency events.

62. The method of claim 61 wherein the step of responding to the request message comprises transmitting a response message indicating an acceptance of the media channel from the CES to the packet network, the method further comprising the step of:
receiving the response message in the one resource over the packet network, and initiating a process to dynamically establish the media channel between the CES and the one resource.

63. The method of claim 61 wherein the step of responding to the request message comprises:
initiating a process in the CES to dynamically establish the media channel between the CES and the one resource.

64. The method of claim 61 further comprising the step of:
negotiating parameters of the media channel.

65. The method of claim 61 wherein the communication network further comprises a channel setup system connected to the packet network, and the step of transmitting a request message from the one resource to the packet network comprises:
transmitting the request message from the one resource to the channel setup system; and
receiving the request message in the channel setup system, and transmitting the request message to the CES.

66. The method of claim 65 wherein the step of responding to the request message comprises transmitting a response message indicating the acceptance of the media channel from the CES to the channel setup system, the method further comprising the steps of:
receiving the response message in the channel setup system and transmitting the response message to the one resource.

67. The method of claim 65 wherein the step of responding to the request message comprises transmitting a response message indicating the acceptance of the media channel from the CES to the one resource.

68. The method of claim 65 wherein the channel setup system comprises a Session Initiation Protocol (SIP) proxy or a SIP server.

69. The method of claim 65 further comprising the steps of:
generating another request message in the channel setup system, selecting another one of the resources in the emergency services network, and transmitting the other request message to the CES to dynamically establish another media channel between the other resource and the CES.

70. The method of claim 61 further comprising the step of:
dynamically establishing the media channel using Session Initiation Protocol (SIP).

71. The method of claim 70 wherein the request message comprises a SIP Invite message.

72. The method of claim 61 further comprising the step of:
tearing down the media channel.

73. The method of claim 61 wherein the plurality of resources includes a response gateway.

74. The method of claim 61 wherein the plurality of resources includes at least one of an ALI database, a Mobile Positioning Center (MPC), a Gateway Mobile Location Center (GMLC), an Emergency Auxiliary Service Provider (EASP), and a Voice over Internet Protocol (VoIP) server.

75. The method of claim 61 wherein the CES comprises a computer system for a Public Safety Answering Point (PSAP).

76. The method of claim 61 wherein the CES comprises a computer system for one of a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

77. The method of claim 61 wherein the emergency events include 9-1-1 calls.

78. The method of claim 61 wherein the step of exchanging messages comprises:
exchanging at least one of streaming video, streaming audio, voice, graphics, text data, binary data, and executable instructions or scripts over the media channel.

79. A conforming emergency system (CES) for dynamically establishing media channels with resources of an emergency services network, the CES comprising:
a channel system that transmits a request message for a media channel to a packet network, and
a message system, responsive to the media channel being established with one of the resources of the emergency services network, that exchanges messages over the media channel with the one resource to facilitate the CES in handling emergency events.

80. The CES of claim 79 wherein:
the channel system receives a response message indicating the acceptance of the media channel by the one resource, and initiates a process to dynamically establish the media channel between the CES and the one resource.

81. The CES of claim 80 wherein the channel system uses Session Initiation Protocol (SIP) to dynamically establish the media channel.

82. The CES of claim 81 wherein the request message comprises a SIP Invite message.

83. The CES of claim 81 wherein the channel system comprises a SIP user agent.

84. The CES of claim 79 wherein:
the channel system negotiates parameters of the media channel before the media channel is dynamically established.

85. The CES of claim 79 wherein the CES comprises a computer system for Public Safety Answering Point (PSAP).

86. The CES of claim 79 wherein the CES comprises a computer system for one of a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

87. A method of operating a conforming emergency system (CES) to dynamically establish media channels with resources of an emergency services network, the method comprising the steps of:
transmitting a request message for a media channel to a packet network; and
responsive to the media channel being established with one of the resources of the emergency services network, exchanging messages over the media channel with the one resource to facilitate the CES in handling emergency events.

88. The method of claim 87 further comprising the steps of:
receiving a response message indicating the acceptance of the media channel from the one resource of the emergency services network, and initiating a process to dynamically establish the media channel between the CES and the one resource.

89. The method of claim 88 wherein the step of initiating a process to dynamically establish the media channel comprises dynamically establishing the media channel using Session Initiation Protocol (SIP).

90. The method of claim 89 wherein the request message comprises a SIP Invite message.

91. The method of claim 87 further comprising the step of:
negotiating parameters of the media channel before the media channel is dynamically established.

92. The method of claim 87 wherein the CES comprises a computer system for a Public Safety Answering Point (PSAP).

93. The method of claim 87 wherein the CES comprises a computer system for one of a hospital, a police department, a fire station, a fire alarm company, a security company, an ambulance service, a state 9-1-1 coordinator, the Federal Emergency Management Agency (FEMA), the Department of Homeland Security, the National Geophysical Data Center, or the Center for Disease Control (CDC).

94. A conforming emergency system (CES) for dynamically establishing media channels with resources of an emergency services network, the CES comprising:
a channel system that receives a request message for a media channel from one of the resources of the emergency services network over a packet network, and responds to the request message to dynamically establish the media channel between the CES and the one resource; and
a message system, responsive to the media channel being established, that exchanges messages over the media channel with the one resource to facilitate the CES in handling emergency events.

95. The CES of claim 94 wherein the channel system uses Session Initiation Protocol (SIP) to dynamically establish the media channel.

96. A method of operating a conforming emergency system (CES) to dynamically establish media channels with resources of an emergency services network, the method comprising the steps of:
receiving a request message for a media channel from one of the resources over a packet network;
responding to the request message to dynamically establish the media channel between the CES and the one resource; and
exchanging messages over the media channel with the one resource to facilitate the CES in handling emergency events.

97. The method of claim 96 wherein the step of dynamically establishing the media channel comprises dynamically establishing the media channel using Session Initiation Protocol (SIP).
